(19) United States
(12) Patent Application Publication
(10) Pub. No.: US 2009/0273453 A1
(43) Pub. Date: Nov. 5, 2009

(54) Item Identification Using RFID

(75) Inventor: Mark E. Tuttle, Meridian, ID (US)

Correspondence Address: GREENBERG TRAURIG, LLP (SV3), IP DOCKETING, 2450 COLORADO AVENUE SUITE 400E, SANTA MONICA, CA, 90404, US

(73) Assignee: KEYSTONE TECHNOLOGY SOLUTIONS, LLC, Boise, ID (US)

(21) Appl. No.: 12/115,127

(22) Filed: May 5, 2008

(51) Int. Cl. H04Q 5/22

(52) U.S. Cl. 340/10.42

(57) ABSTRACT

Methods and apparatus, including computer program products, for item identification using RFID. A system includes a radio frequency identification (RFID) interrogator, and a computer coupled to the RFID interrogator, the computer including a database comprising RFID identification codes and items associated with the RFID identification codes, two or more the RFID identification codes associated with a single item.

### BACKGROUND

The present invention relates to data processing by digital computer, and more particularly to item identification using RFID.

As large numbers of objects are moved in inventory, product manufacturing, and merchandising operations, there is a continuous challenge to accurately monitor the location and flow of objects. One way of tracking objects is with radio frequency identification (RFID).

RFID is a technology that incorporates the use of electromagnetic or electrostatic coupling in the radio frequency (RF) portion of the electromagnetic spectrum to uniquely identify an object, animal, or person. With RFID, the electromagnetic or electrostatic coupling in the RF (radio frequency) portion of the electromagnetic spectrum is used to transmit signals. A typical RFID system includes an antenna and a transceiver, which reads the radio frequency and transfers the information to a processing device (reader) and a transponder, or RF tag, which contains the RF circuitry and information to be transmitted. The antenna enables the integrated circuit to transmit its information to the reader that converts the radio waves reflected back from the RFID tag into digital information that can then be passed on to computers that can analyze the data.

### SUMMARY

The present invention provides methods and apparatus, including computer program products, for item identification using RFID.

In general, in one aspect, the invention features a system including a radio frequency identification (RFID) interrogator, and a computer coupled to the RFID interrogator, the computer including a database including RFID identification codes and items associated with the RFID identification codes, two or more of the RFID identification codes associated with a single item.

In another aspect, the invention features a method including, in a store of radio frequency identification (RFID) codes representing RFID tags, assigning two or more radio frequency (RFID) identification codes to a single item.

In another aspect, the invention features a method including interrogating an item having radio frequency identification (RFID) tags with a RFID interrogator, each of the RFID tags having a unique RFID identification code, receiving a RFID identification code from one of the RFID tags on the item in response to interrogating, and identifying the item in a store that associates each of the unique RFID identification codes of each of the RFID tags to a single tagged item.

Other features and advantages of the invention are apparent from the following description, and from the claims.

### BRIEF DESCRIPTION OF THE DRAWINGS

FIG. 1 is a block diagram of an exemplary radio frequency identification (RFID) system.

FIG. 2 is a block diagram of an exemplary RFID interrogator.

FIG. 3 is a block diagram of an exemplary RFID tag.

FIG. 4 is a block diagram of an exemplary database.

FIG. 5 is a flow diagram of an exemplary RFID tracking process.

Like reference numbers and designations in the various drawings indicate like elements.

### DETAILED DESCRIPTION

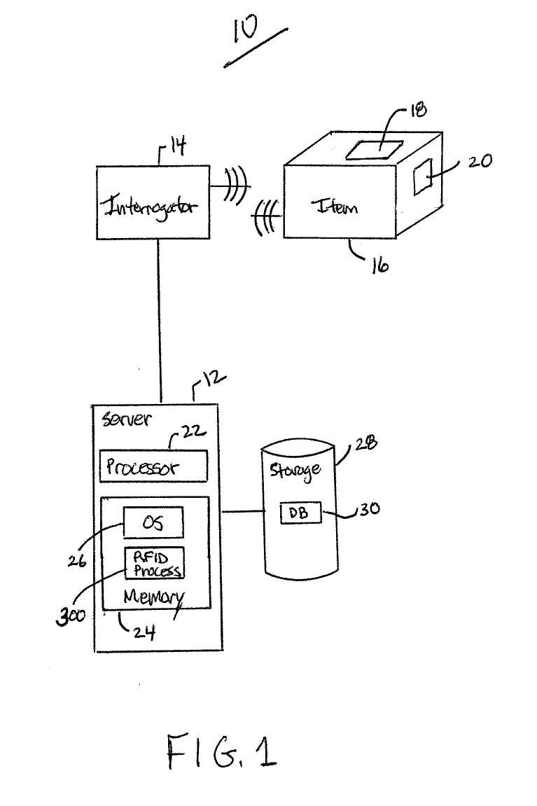

As shown in FIG. 1, an exemplary radio frequency identification (RFID) system 10 includes a server 12 coupled to a RFID interrogator 14. The RFID system 10 includes an item 16 having two RFID tags 18, 20 (also referred to as RFID labels or RFID devices) affixed thereto. In other examples, any number of RFID tags can be affixed to the item 16.

Item 16 can represent any article being tracked, such as an item of inventory or an item contained on a shipping pallet. In this example, the RFID tags 18, 20 are oriented in two different planes on the item 16 to increase the probability of being seen and read when in proximity to the RFID interrogator 14. In other examples, multiple RFID tags can be affixed on multiple planes of the item 16.

The server 12 includes, for example, a processor 22 and memory 24. Memory 24 includes an operating system (OS) 26, such as Linux or Windows®, and a RFID tracking process 300, described below. The server 12 also includes a storage device 28 including a database 30. Database 30 can be a flat file or a database management system, for example. The database 30 is used to maintain an association between unique identification codes of RFID tags and items. More particularly, multiple RFID tags, affixed to a single item, have their unique RFID identification codes associated with that single item, rather than a single RFID tag and its unique RFID code associated with only a single item.

The database 30 stores entries that relate two or more RFID identification codes to a single item. Each RFID identification code is stored on a respective chip associated with an antenna/chip pair attached to a RFID tag (e.g., in different orientations, such as perpendicular or for wrapping around a corner). A read of any one of the RFID identification codes is good enough to log the presence of the tagged item, which improves read success rate, because all of the RFID identification codes of RFID tags affixed to one single item refer to that tagged item.

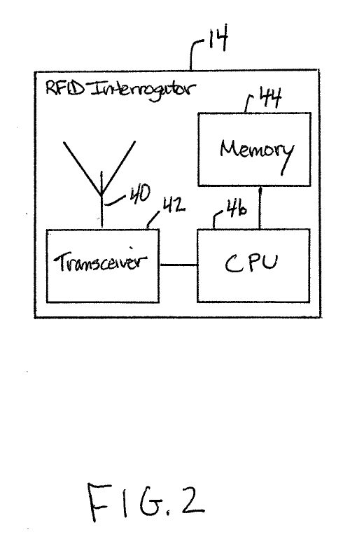

As shown in FIG. 2, the RFID interrogator 14 includes an antenna 40, transceiver 42, memory 44 and processor 46. The memory 44 and processor 46 can be implemented as a microcontroller. The RFID interrogator 14 is programmable and performs, in one example, Time Division Multiplexing (TDM) with the transceiver 42 and antenna 40. Data downloaded from a RFID tag, such as RFID tags 18, 20, can be stored in memory 44. This data includes a RFID identification code stored in each of the respective RFID tags 18, 20.

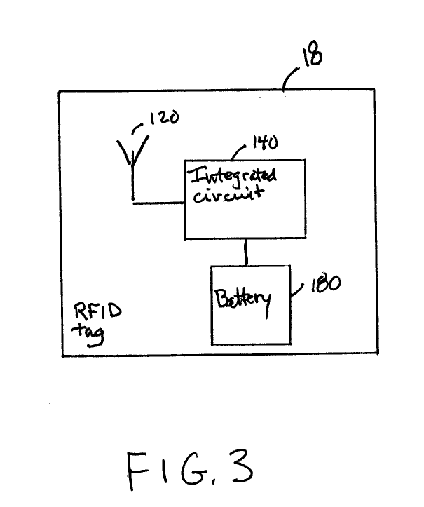

As shown in FIG. 3, each of the RFID tags 18, 20, such as RFID tag 18, includes an antenna 120, coupled to an integrated circuit 140, and in some configurations, a battery 180. The integrated circuit 140 performs various functions, such as, storing and processing information, and modulating/demodulating a radio frequency (RF) signal. The antenna 120 receives and transmits signals. When triggered by RF interrogation the integrated circuit 140 fetches data (e.g., time stamp, unique RFID identification code and so forth) and sends it out to an interrogator, such as RFID interrogator 14.

As described above, each of the RFID tags 18, 20 includes a unique RFID identification code that is passed to the RFID interrogator 14 when the RFID tag is interrogated. Depending on the orientation of any RFID tag with respect to the RFID interrogator 14 (e.g., placement of the RFID tag with respect to the interrogator), the interrogator 14 will receive a response (e.g., RFID identification code) from the RFID tag (i.e., a good read) or fail to receive a response from the RFID tag (i.e., a bad read). As described above, to facilitate and increase the number of good reads, the database 30 associates two or more RFID identification codes with a single item 16. When either one of the RFID tags 18, 20 are interrogated and send their RFID identification code to the RFID interrogator 14, the RFID interrogator 14 sends the received RFID identification code to the server 12 and the RFID tracking process 300 identifies the item associated with the received RFID identification code. In this manner, the read of the RFID tag is a good read of the item 16.

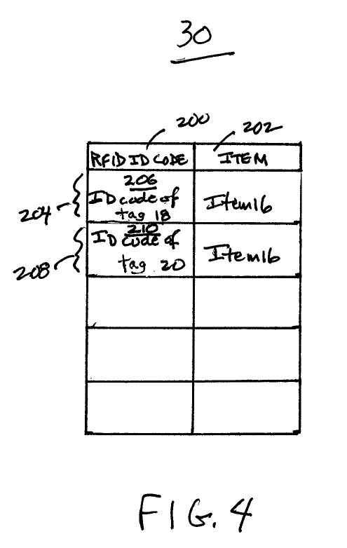

As shown in FIG. 4, using the above example, database 30 includes entries of RFID identification codes 200 and the items 202 each of the respective identification codes represent. The database 30 is used to associate a single item with multiple RFID identification codes. For example, entry 204 includes a RFID identification code 206 representing RFID tag 18 and the item 16. Entry 208 includes a RFID identification code 210 representing RFID tag 20 and the item 16. When either RFID tag 18 or tag RFID tag 20 is read by interrogator 14, it sends the received RFID identification code to the server 12 where the received RFID identification code refers to item 16.

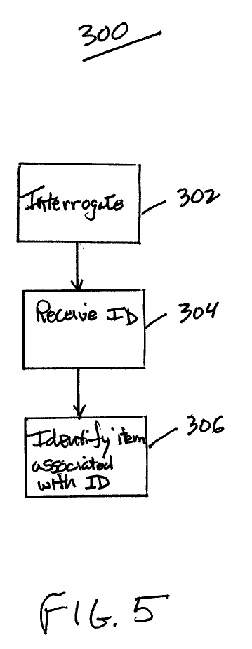

As shown in FIG. 5, RFID tracking process 300 includes interrogating (302) an item having more than one radio frequency identification (RFID) tag with a RFID interrogator. Each of the RFID tags has a unique RFID identification code.

Process 300 receives (304) a RFID identification code from one of the RFID tags on the item in response to interrogating (302).

Process 300 identifies (306) the item in a store that associates multiple unique RFID codes to a single tagged item.

The invention can be implemented to realize one or more of the following advantages.

A database associates multiple RFID codes (i.e., IDs) to a single RFID tagged item. Each RFID code is stored on a respective chip associated with an antenna/chip pair attached to the single RFID tag (e.g., in different orientations, such as perpendicular or for wrapping around a corner). A read by an interrogator of any one of the RFID codes of multiple RFID tags affixed to the same item is good enough to log the presence of the tagged item, which improves read success rate.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; CD ROM and DVD-ROM disks; and solid-state drives. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A system comprising:
a radio frequency identification (RFID) interrogator; and
a computer coupled to the RFID interrogator, the computer including a database comprising RFID identification codes and items associated with the RFID identification codes, two or more of the RFID identification codes associated with a single item.

2. The system of claim 1 further comprising two or more RFID tags affixed to the single item, each of the RFID tags including a unique RFID identification code.

3. The system of claim 2 wherein the database comprises an entry associating the RFID identification codes of the two or more RFID tags to the single item.

4. The system of claim 1 wherein in the computer is a server in a network.

5. A method comprising:
in a store of radio frequency identification (RFID) codes representing RFID tags, assigning two or more radio frequency (RFID) identification codes to a single item.

6. The method of claim 5 further comprising:
interrogating an item having an affixed first RFID tag and an affixed second RFID tag, the store associating a first RFID identification code of the first RFID tag with the item and a second RFID identification code of the second RFID tag with the item;
receiving the first RFID identification code from the first RFID tag in response to interrogating; and
identifying the item in the store associated with the first RFID identification code.

7. The method of claim 5 wherein the store is a database.

8. The method of claim 7 wherein the database resides in a network server.

9. A method comprising:
interrogating an item having a plurality of radio frequency identification (RFID) tags with a RFID interrogator, each of the RFID tags having a unique RFID identification code;
receiving a RFID identification code from one of the plurality of RFID tags on the item in response to interrogating; and
identifying the item in a store that associates each of the unique RFID identification codes of each of the plurality of RFID tags to a single tagged item.

10. The method of claim 9 further comprising logging the identity of the item.

11. The method of claim 10 wherein logging comprises storing the identity of the item in a server coupled to the interrogator.

12. A computer program product, tangibly embodied in an information carrier, for storing data and identifying items, the computer program product being operable to cause data processing apparatus to:
interrogate an item having a plurality of radio frequency identification (RFID) tags with a RFID interrogator, each of the RFID tags having a unique RFID identification code;
receive a RFID identification code from one of the plurality of RFID tags on the item in response to interrogating; and
identify the item in a store that associates multiple unique RFID codes to a single tagged item.

13. The computer program product of claim 12 wherein the store indicates that each of the plurality of RFID identification codes of the plurality of RFID tags are associated with the item.

14. The computer program product of claim 12 further operable to cause data processing apparatus to:
log the identity of the item.

15. The computer program product of claim 14 wherein logging comprises storing the identity of the item in a server coupled to the interrogator.
